(19) United States
(12) Patent Application Publication
(10) Pub. No.: US 2004/0243495 A1
(43) Pub. Date: Dec. 2, 2004

(54) Automated negotiation

(76) Inventor: Alan H. Karp, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/452,527

(22) Filed: Jun. 2, 2003

(51) Int. Cl. G06F 17/60

(52) U.S. Cl. 705/35

(57) ABSTRACT

A system and method for automated negotiation. An embodiment of the method for automated negotiation comprises constructing a game tree based on an offer received from an opponent; evaluating the game tree; and selecting a counteroffer based on the evaluation of the game tree.

### BACKGROUND

As more commerce moves to the Internet, and other computer networks, companies increasingly rely on software and computer systems to do business on their behalf. As a result, many processes formerly done by people are now being automated. For example, buyers can browse, shop, and purchase products directly from their computer. In fact, both the selling and purchasing processes have been automated in some industries such that the sellers' computer software and systems can post products to be sold on the Internet, while buyers' computer software and systems can search the Internet for products to be purchased. If the products are available, and at desirable terms, a transaction may be completed in an entirely automated process by the seller and buyer, or more accurately, by their computers.

In the tangible marketplace, however, many transactions involve negotiation between the buyer and seller. Such negotiation may involve reiterative offers and counteroffers relating to the terms of the sale such as price, delivery, warranty, payment options, and product features, for example. Given the relative complexity of such negotiations, automating this negotiation process presents a significant challenge.

In the gaming world, many contests between parties have been successfully automated. In fact, an entire industry of automated games has been developed. Even traditional games have been successfully automated (such as chess, checkers, tic-tac-toe, etc.). One technique for automating games is to use computer gaming strategy. Computer gaming strategy often involves building a game tree that allows the computer to consider the options presented as the game progresses in order to select options at each stage that will most likely result in a win. Other attempts to automate games have included heuristic approaches that attempt to emulate human behavior. The game tree strategy, however, uses the available computing power to produce comparable or better results than the heuristic models.

A game tree generally comprises nodes representing the various states (stages or positions) that may occur during the game. A root node represents the current state. Under each root node, a child node represents an option (or move) that is available from the root node. When there are no further options available from a node, the node is called a terminal node. By expanding the game tree to all terminal nodes, all possible options can be represented and considered. Complete expansion of a game tree may be relatively easy for a simple game such as tic-tac-toe, but may be much more complicated for a more involved game such as chess. Ultimately, the desirability of any move from a root node (current state) to a child node (an available option) can be evaluated based on the desirability of the tree under each child node. For example, if a root node has 2 child nodes, representing 2 available options, the party should choose the option with the higher payoff, that is, the option that gives the party the win or is most likely to lead to a win. The option with the highest payoff can be determined by evaluating the sub-tree beneath each node, for example by evaluating the likelihood of a favorable outcome for each sub-tree under the child nodes.

By considering the decision-making process in such a structured manner, computers can be utilized to evaluate the available options as the contest progresses and to select the options most likely to lead to a favorable outcome. The simpler the options, the easier it is to construct and to evaluate a game tree. The more complex the options, the more complicated the game tree will be to construct and evaluate.

Negotiations involving business dealings present several complexities not normally found in a standard game or contest. For example, numerous attributes (or terms) may be negotiated at the same time, such as price, payment systems, delivery date, product specifications, etc. These numerous attributes result in the possibility of compound moves where more than one attribute is changed at a time. The possibility of compound moves creates significantly more available options at any point in the contest. In addition, changing the attributes may not present finite, discrete options or moves. Attributes such as price, volume, and time of delivery, for example, represent a continuum of options (or effectively a continuum). In chess or a similar standard contest, a finite number of available moves typically exist at any time in the contest. If the attributes of the contest are relatively continuous, however, in effect there may be a theoretically infinite number of available options to modify the attribute. To consider all such options would require a theoretically infinite game tree. Additionally, in a standard contest the opponent's desired outcome is usually known. For example, in most standard win-lose contests it can reasonably be assumed that the opponent wants to win the contest and a win is clearly definable. In a business dealing, however, it may be unclear what the opponent desires, or more specifically, what constitutes a win for the opponent. There may be more than one favorable outcome to the opponent.

Such complexities make the utilization of computers to perform automated negotiations encompassing business dealings, or other contests having similar complexities, a difficult proposition.

### BRIEF SUMMARY

Automated negotiation is disclosed. An embodiment of a method for automated negotiation comprises constructing a game tree based on an offer received from an opponent, evaluating the game tree, and selecting a counteroffer based on the evaluation of the game tree.

### BRIEF DESCRIPTION OF THE DRAWINGS

For a detailed description of the embodiments of the invention, reference will now be made to the accompanying drawings in which:

FIG. 1 is a flow chart illustrating an embodiment of a method for automated negotiation;

FIG. 2 is a diagram illustrating the construction of a game tree for use in an automated negotiation including compound moves in accordance with embodiments of the invention;

FIG. 3 is a diagram illustrating the construction of a game tree for use in an automated negotiation including range terms in accordance with embodiments of the invention;

FIG. 4 is a diagram illustrating the evaluation of a game tree for use in an automated negotiation in accordance with embodiments of the invention; and

FIG. 5 is a system diagram illustrating an embodiment of a general-purpose computer system on which a system and method for automated negotiation could be operated, in whole or in part, in accordance with embodiments of the invention.

### NOTATION AND NOMENCLATURE

Certain terms are used throughout the following description and claims to refer to particular components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical or communicative connection. Thus, if a first device couples to a second device, that connection may be through a direct connection, or through an indirect connection via other devices and connections. As used herein the term negotiation will be used broadly to reference any dealing between at least two parties where each party vies for a favorable outcome, i.e., an outcome that serves the party's interests. Accordingly, the term negotiation will encompass business dealings (such as negotiations involving the terms of a deal, bargaining, and bartering, for example), as well as other more traditional contests between parties (such as competition or games).

### DETAILED DESCRIPTION

The following discussion is directed to various embodiments of the invention. Unless otherwise specified, the embodiments disclosed should not be interpreted as limiting, or otherwise used to limit, the scope of the disclosure or claims. In addition, one skilled in the art will understand that the following description has broad application. The discussion of any embodiment is meant only to be exemplary of that embodiment and is not intended to suggest that the scope of the disclosure or claims is limited to that embodiment. In this disclosure, numerous specific details may be set forth to provide a sufficient understanding of the embodiment. However, those skilled in the art will appreciate that the invention may be practiced without such specific details. In other instances, well-known elements may have been illustrated in schematic or block diagram form in order not to obscure the disclosure in unnecessary detail. Additionally, some details may have been omitted where such details were not considered necessary to obtain a complete understanding of the embodiment, and are considered to be within the understanding of persons of ordinary skill in the relevant art. Further, all functions described herein may be performed in either hardware or software, or a combination thereof, unless indicated otherwise.

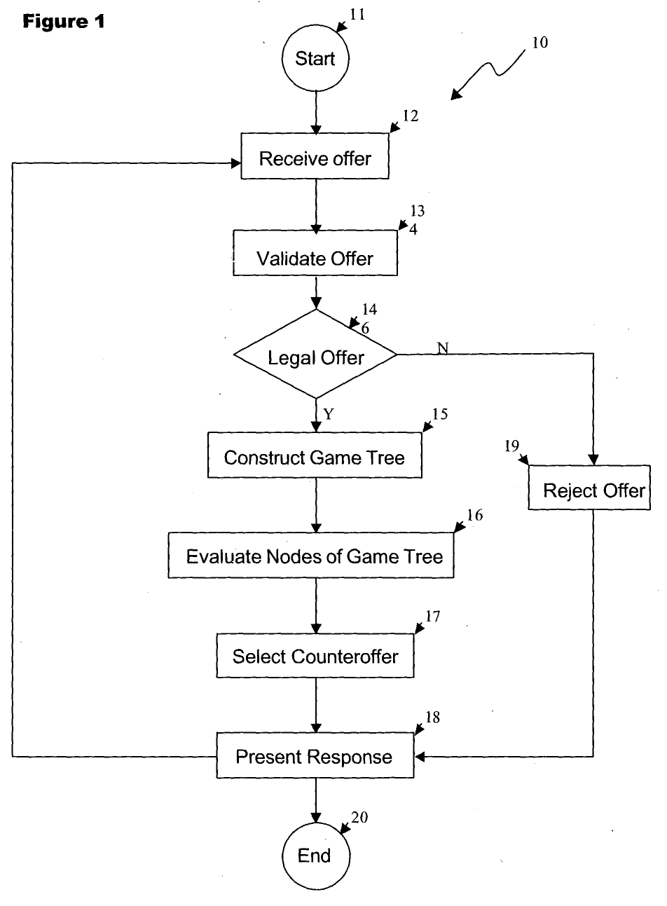

Referring initially to FIG. 1, a flow chart illustrates an embodiment of a method 10 for automated negotiation using game tree strategy. The method starts at box 11. In box 12, an offer is received. Since a negotiation may be viewed as a type of contest, the opposite party in the negotiation may be referred to as the opponent. Thus, the offer is received from the opponent in box 12. The offer may include numerous terms or “attributes” of the deal being negotiated. In standard negotiations, the goal is generally to negotiate the attributes of the deal in your favor, and correspondingly, not to enter into a bad deal. A negotiation may be viewed conceptually as filling in the blanks of a contract where each blank corresponds to an attribute of the deal. As each attribute is agreed upon, the blank in the contract is filled. When all attributes have been determined, the contract is complete and a deal has been made. For an automated process of negotiation to proceed efficiently, once attributes are agreed upon they cannot be re-negotiated. If attributes could be continually re-negotiated, there is the potential for a continuous repetitive cycle of negotiation to occur. Thus, certain constraints on the negotiation may be needed in order to automate the negotiation process, or to make the automated process efficient.

In box 13, a validation of the offer begins. The validation may include a determination of how the offer should be categorized and ultimately how to respond to the offer appropriately. For example, the validation may include identifying the opponent making the offer and the subject matter of the offer to ensure the offer relates to the current deal being negotiated. Additionally, the process may make a determination of whether the offer constitutes a legal offer as defined by the specific automated negotiation process. For example, box 14 determines whether the offer is a legal offer. An offer is not a legal offer if it violates a constraint. For purposes of automating the negotiation process, certain constraints may be placed on the negotiation process. In this embodiment of the method 10, a legal counteroffer narrows the range of potential deals by eliminating or narrowing an attribute of the deal. This constraint also protects against a continuous repetitive loop in the automated negotiation process since if the offer does not narrow or eliminate an attribute, the negotiation may not proceed to a conclusion. If it is not a legal offer, then there can be no valid counteroffer and the offer is rejected in box 19. When an offer has been rejected, a response is presented to the opponent in the negotiation in box 18. In this case, the response would be a rejection of the illegal offer. Once a response has been presented to the opponent, the method 10 may continue to box 12 to await the receipt of another offer or the process may end at box 20.

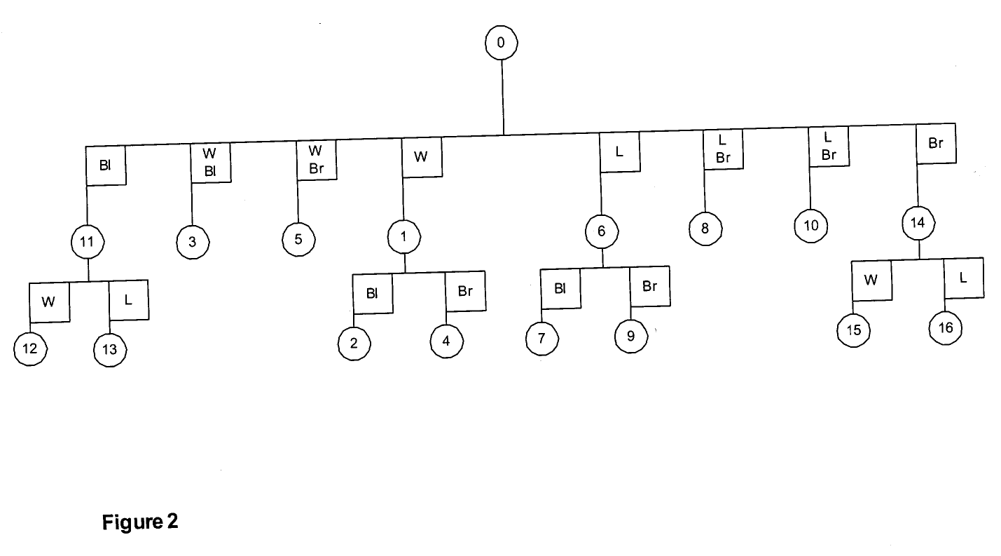

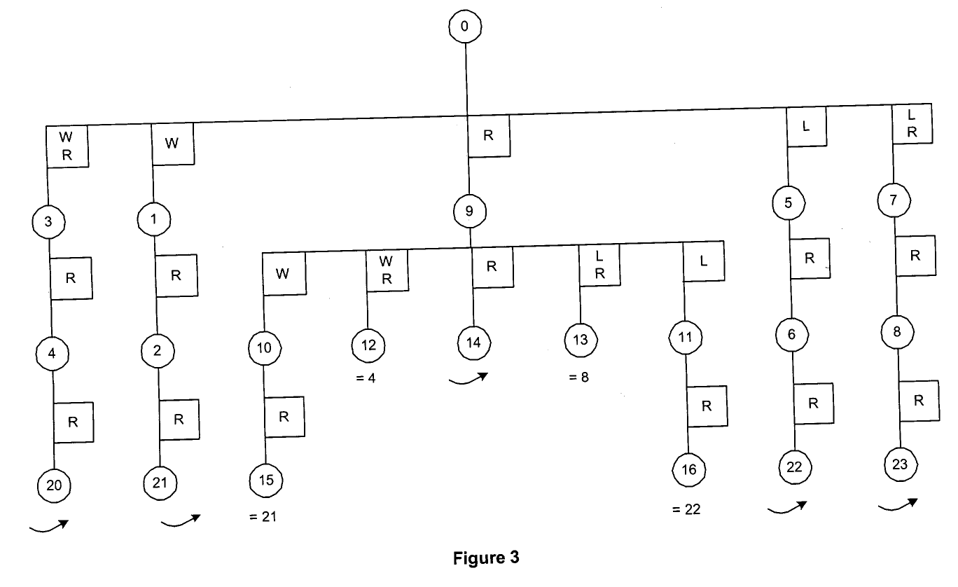

If the offer does not violate any of the constraints and thus qualifies as a legal offer, the method 10 continues to box 15. In box 15, a game tree is constructed based on the offer received. The game tree generally comprises nodes representing the various states of the negotiation. The construction of a game tree is discussed in more detail in reference to FIG. 2 below. Once the game tree has been constructed, the nodes of the game tree are evaluated in box 16. The evaluation of the game tree includes assigning a payoff value to each node that represents the node's desirability in terms of offering the best payoff to the party from the negotiation that has the option to move to that node. The evaluation of the game tree is discussed in more detail in reference to FIG. 3 below. In box 17, a counteroffer is selected. Generally, the counteroffer having the highest payoff is chosen from the available counteroffers. The selected counteroffer can then be presented as a response to the opponent in box 18. Once the counteroffer has been presented to the opponent, the method 10 may continue to box 12 to await the receipt of another offer from the opponent in response to the counteroffer or the process may end at box 20. Although the process may end at anytime, generally the negotiation process continues reiteratively until all attributes of the deal have been completed (and thus there are no more available counteroffers).

FIG. 2 is a diagram illustrating the construction of a game tree for use in an automated negotiation. A game tree consists of nodes and branches. The nodes represent states of the negotiation. The branches represent the path or logical procession between the nodes. Branches can be viewed as representing the moves required to transition from one state or node to another. As shown in FIG. 2, each node of the game tree is represented by a circle. A reference number within the circle identifies each individual node. For example, node 0 is shown at the top of the tree. The branches are represented by the lines connecting the nodes.

In general, a game tree is constructed as follows. A current node of the game tree represents the current position or state of the negotiation. In a business negotiation, the current node would represent the current offer. In FIG. 2, the current node would be node 0. A child node is created for every legal move or option from the current node. Thus in a business negotiation, each available counteroffer is represented as a child node from the current node. In FIG. 2, nodes 1, 3, 5, 6, 8, 10, 11 and 14 are the child nodes of node 0. A branch is drawn between the current node and each available child node from the current node. The branches represent how a party would move or progress to each node. The current node and child node(s) can be viewed as a game tree having a depth of two levels. Additional levels of the game tree are completed by the creation of additional nodes under each child node where each additional node represents the available options (i.e., available offers or counteroffers in a business negotiation) from the preceding child node. This process recursively continues creating nodes that represent the available options from the preceding node. In this way, sub-trees are created under each child node. Generally, the construction process continues and the game tree is expanded until there are no further nodes or moves to examine, or until the process runs out of time. The game tree may be expanded to include all available options so that a complete analysis of the game tree can be conducted. Thus, the game tree may be expanded under each child node until all terminal nodes are reached. If there are no legal moves from a node, the node is referred to as a “leaf” or terminal node. Terminal nodes have no child nodes because there are no further options available. In FIG. 2, nodes 2, 3, 4, 5, 7, 8, 9, 10, 12, 13, 15, and 16 are terminal nodes. In a business negotiation, terminal nodes represent conclusions to the negotiation process in which there are no other available counteroffers to the last offer.

Pruning strategies may be implemented to manage the size of the game tree. If the game tree becomes too large, the automated negotiation process may become difficult to automate as the tasks of constructing the game tree and evaluating the game tree may become too burdensome. To conserve time and resources in the process, various branches of the tree may be “pruned.” For example, if a particular node in the tree violates a specific constraint, such as delivering the product too late for it to be useful, then the sub-tree need not be expanded. Alternatively, if the best possible deal from one node is less desirable than the worst possible deal from another node, the sub-tree under the former node need not be expanded. Additionally, if these pruning strategies do not result in a sufficiently small game tree, then the construction of the game tree can be halted before reaching a terminal node and the value of the node and sub-tree thereunder can be estimated. Another example of a pruning strategy is simply to set a time limit on the construction of the game tree. Once the time limit is reached, the game tree must be evaluated even though the game tree may not be complete and may not include all of the available options. Of course, pruning the tree may affect the accuracy of the evaluation performed since by definition not all options are being considered.

In a business negotiation, the construction of the game tree may be further complicated by the fact that valid offers or counteroffers may change more than one attribute of the deal at a time. Offers or counteroffers that change more than one attribute of the deal at a time shall be referred to herein as compound moves. To accommodate compound moves, the construction of the game tree could comprise a determination of all possible options (or counteroffers) available from the current node. Such options would include moves that change a single attribute as well as those that change multiple attributes. Thus, nodes would be generated for the compound moves just as nodes are generated for moves changing a single attribute at a time. Alternatively, compound moves can be viewed as a combination of moves that change a single attribute. Accordingly, constructing the game tree can comprise determining all available moves that change a single attribute from a current node. For each such available move, a child node and a sibling node can be created. The sibling node represents a combination of the move used to create the child node and the move required to reach the current node. By combining the moves, a sibling node can be created which represents a single offer comprising multiple moves. In this way, the construction of the game tree incorporates compound moves.

FIG. 2 illustrates the construction of a game tree for an automated negotiation having compound moves. For purposes of illustration, the current node, node 0, shall represent the current status of a negotiation for a pair of shoes in which there are only two remaining attributes to be negotiated: type of shoes and color of shoes. To further simplify the illustration of FIG. 2, there are only two available states for these attributes. The shoe type can be wingtips (W) or loafers (L). The shoe color can be black (Bl) or brown (Br). The construction of the game tree in FIG. 2 begins by determining legal counteroffers available from the current node, node 0. These legal counteroffers will be child nodes of node 0. Assuming a constraint that legal counteroffers must narrow-the attributes of the deal, legal counteroffers would include selecting a state for one of the remaining two attributes. For example, the shoe type attribute can be addressed first. The shoe type may be wingtips or loafers. Node 1 is created to represent a counteroffer where wingtips have been selected. A branch is drawn from the root node, node 0, to this child node, node 1. Flags are shown on the branches in FIG. 2 to illustrate how the move represented by the branch would be accomplished. For example, a flag having a “W” is shown on the branch to node 1 to show that this attribute state (wingtips) would be selected to move to node 1. Repeating a similar process from node 1, node 2 is created to represent a further move in which the shoe color has been selected as black. A branch is drawn from node 1 to node 2 to represent this move. A flag having “Bl” is shown on the branch to indicate how node 2 is reached from node 1. At this point, a sibling node, node 3, can be created as a child node to the root node, node 0. Sibling node 3 represents the combined moves required to reach node 1 and then node 2, that is the selection of wingtips and the color black. This combined move is represented on the branch to node 3 as a flag bearing a “W” and “Bl”. Similarly, node 4 is created beneath node 1 to represent a selection of the color brown. A flag on the branch to node 4 bears “Br” to represent the selection made (brown) to move to node 4. Again, a sibling node, node 5, can be created to represent the combined moves required to reach node 4 from node 1, that is the selection of wingtips and the color brown. The flag on the branch to sibling node 5 indicates the combined move with a “W” and “Br”. Since no further moves or options are available from nodes 2, 3, 4, and 5 these are terminal nodes.

In a similar and recursive fashion, nodes 6, 7, 8, 9, and 10 are created. Node 6 represents a counteroffer where loafers have been selected. Node 7 further narrows the deal by selecting the color black and node 9 selects the color brown. Node 8 is a sibling node representing the combined moves necessary to reach node 7 (loafers, black). Node 10 is a sibling node representing the combined moves necessary to reach node 9 (loafers, brown). Since no further moves or options are available from nodes 7, 8, 9 and 10 these are terminal nodes.

Further repeating the construction process, node 11 is created to represent the counteroffer where the color black is selected. Nodes 12 and 13 represent further narrowing of the deal by selecting wingtips and loafers respectively. Node 14 is created to represent the counteroffer where the color brown is selected. Nodes 15 and 16 represent further narrowing of the deal by selecting wingtips and loafers respectively. Note that sibling nodes do not have to be created to represent the moves to nodes 12, 13 nor to nodes 15, 16 because these sibling nodes would be identical to the sibling nodes already created. Since no further moves or options are available from nodes 12, 13, 15, and 16 these are terminal nodes. Since no further legal counteroffers can be created under the root node, node 0, the construction of the game tree of FIG. 2 is complete.

Referring now to FIG. 3, FIG. 3 is another diagram illustrating the construction of a game tree for use in an automated negotiation. Further complicating the construction of a game tree for use in automated negotiations is the possibility for range-valued attributes. Range-valued attributes are terms of the deal whose values may vary within a given range or continuum. Such attributes shall be referred to herein as “range terms”. In standard contests or games the moves are generally discrete. For example, in chess each piece can only perform certain discrete moves. As a result, there are a finite number of moves available to the chess player at any given time. Accordingly, constructing the associated game tree necessarily contemplates a finite number of nodes. In business negotiations, however, there may be attributes or terms of the deal that are continuous, or effectively continuous, such as fluid measurements, delivery dates, and price, for example. Thus, a legal move in a business negotiation might include an infinite or virtually infinite number of options within the range of the attribute. Accordingly, the associated game tree might comprise an infinite or virtually infinite number of nodes as a result of such range terms. The prospect of an infinite number of nodes in the game tree is problematic since it would create time and resources problems in both the construction and evaluation of the game tree.

To accommodate such range terms in the construction of a game tree, a practical granularity could be enforced on the range terms. In the natural course of business dealings certain increments in the range terms may become negligible such that imposing a granularity on the terms may become appropriate. In a negotiation to buy a house, for example, price changes typically occur in increments of thousands or hundreds of dollars rather than tens or ones of dollars. This is because tens or ones of dollars become negligible to most parties in comparison to the price of the house as a whole. Thus, a granularity that limits price offers to $1000 or $100 increments might be very practical. In addition, imposing such granularity would effectively convert the price term to a discrete attribute of the deal. The appropriate granularity, however, would be dependent on the negotiation or the object of the negotiation. Accordingly, this solution would likely require setting the granularity for each specific negotiation which may be cumbersome in many automated negotiation applications.

If imposing a granularity is not appropriate, there are other alternatives for handling range terms. For example, nodes that involve changing only range terms may be marked and the process of constructing that portion of the game tree omitted. In particular, as the instantiation of the child and sibling nodes progresses in the construction of the game tree, nodes may develop in which only range terms are being modified in all subsequent nodes or moves. When this occurs, the pattern of nodes from the child is essentially identical to the pattern from the parent node. Since there is no way to predict how many rounds of offers may occur after that point, there is no need to construct an unknown quantity of repetitive nodes under the child node. The child node can be marked as a range-term node and the construction of the game tree may progress with the instantiation of nodes in other branches. An optimization algorithm can then be used during the evaluation process to determine the payoff value to be assigned to such range-term nodes. Persons of skill in this technology will recognize that various known optimization algorithms can be utilized for this purpose. An example of one such optimization algorithm would be to calculate the payoff for a limited number of values for the range term. From these values an optimal value for the range term may be estimated using linear or non-linear mathematical techniques. The payoff value for the optimal value of the range term can then be computed and that payoff value may be used for the marked range-term node. Thus, the assignment of a payoff value can occur in the evaluation process even though that portion of the tree has not been full expanded.

FIG. 3 is a diagram illustrating the construction of a game tree for use in an automated negotiation including range terms. Essentially the game tree of FIG. 3 is created similarly to that of FIG. 2 in that the nodes and branches are created via repetitive consideration of available options or moves (offers and counteroffers) from each node. The negotiation of FIG. 3 is similarly directed to the sale of a pair of shoes in which there are two remaining attributes in the deal. The remaining attributes for the negation of FIG. 3, however, are the type of shoes and the price of the shoes. The type of shoes is limited to two states: wingtip (W) and loafer (L). The price attribute is a range term that can have a virtually infinite number of values. Assuming a granularity cannot be established to convert the price attribute from a range term to an attribute having discrete states, the range term will be considered using the optimization technique described above.

The construction of the game tree in FIG. 3 begins by determining legal counteroffers available from the current node, node 0. These legal counteroffers will be child nodes of node 0. Again we assume a constraint that legal counteroffers must narrow the attributes of the deal. Thus, legal counteroffers would include selecting a state for one of the remaining two attributes. For example, the shoe type attribute can be addressed first. The shoe type may be wingtips or loafers. Node 1 is created to represent a counteroffer where wingtips have been selected. A branch is drawn from the root node, node 0, to this child node, node 1. Flags are shown on the branches in FIG. 3 to illustrate how the move represented by the branch would be accomplished. For example, a flag having a “W” is shown on the branch to node 1 to indicate that this attribute state (wingtips) would be selected to move to node 1. Repeating a similar process from node 1, node 2 is created to represent a further move in which the shoe price has been modified. A branch is drawn from node 1 to node 2 to represent this move. A flag having “R” is shown on the branch to indicate the range term (R) has been modified and to indicate how node 2 is reached from node 1. Node 21 represents a further offer (from the other party to the negotiation) further modifying the price term as denoted by the “R” on the branch from node 2 to node 21. From this point, the price term can continue to be modified by the parties indefinitely. Accordingly, an indefinite number of nodes could be created beneath node 21 which would all essentially represent the same state as node 2 and node 21. Rather than repeating nodes beneath node 21, the construction of this branch of the game tree is halted and the node is simply marked as a range-term node. A range-term node is denoted in FIG. 3 with an arrow beneath the node.

At this point, a sibling node, node 3, can be identified and created as a child node to the root node, node 0. Sibling node 3 represents the combined moves of selecting wingtips and modification of the price range term. This combined move is represented on the branch to node 3 as a flag bearing a “W” and “R”. Node 4 is created beneath Node 3 since even though the price was previously modified the price can continue to be changed since the price is a range term. Accordingly, a flag with “R” is shown on the branch between node 3 and 4. Node 22 represents a further offer (from the other party to the negotiation) further modifying the price term as denoted by the “R” on the branch from node 4 to node 20. From this point, the price term can continue to be modified by the parties indefinitely. Accordingly, an indefinite number of nodes could be created beneath node 20 which would all essentially represent the same state as node 4 and node 20. Rather than repeating nodes beneath node 20, the construction of this branch of the game tree is halted and the node is simply marked as a range-term node. A range-term node is denoted in FIG. 3 with an arrow beneath the node.

In a similar and recursive fashion, nodes 5, 6, 22, 7, 8, and 23 are created. Node 5 is created to represent a counteroffer where loafers have been selected. A branch is drawn from the root node, node 0, to this child node, node 5. A flag having an “L” is shown on the branch to node 5 to indicate that this attribute state (loafers) would be selected to move to node 5. Repeating a similar process from node 5, node 6 is created to represent a further move in which the shoe price has been modified. A branch is drawn from node 5 to node 6 to represent this move. A flag having “R” is shown on the branch to indicate the range term (R) has been modified and to indicate how node 6 is reached from node 5. Node 22 represents a further offer (from the other party to the negotiation) further modifying the price term as denoted by the “R” on the branch from node 6 to node 22. From this point, the price term can continue to be modified by the parties indefinitely. Accordingly, an indefinite number of nodes could be created beneath node 22 which would all essentially represent the same state as node 6 and node 22. Rather than repeating nodes beneath node 22, the construction of this branch of the game tree is halted and the node is simply marked as a range-term node. A range-term node is denoted in FIG. 3 with an arrow beneath the node.

At this point, a sibling node, node 7, can be identified and created as a child node to the root node, node 0. Sibling node 7 represents the combined moves of selecting loafers and modification of the price range term. This combined move is represented on the branch to node 7 as a flag bearing an “L” and “R”. Node 8 is created beneath Node 7 since even though the price was previously modified the price can continue to be changed, since the price is a range term. Accordingly, a flag with “R” is shown on the branch between node 7 and 8. Node 23 represents a further offer (from the other party to the negotiation) further modifying the price term as denoted by the “R” on the branch from node 8 to node 23. From this point, the price term can continue to be modified by the parties indefinitely. Accordingly, an indefinite number of nodes could be created beneath node 23 which would all essentially represent the same state as node 8 and node 23. Rather than repeating nodes beneath node 23, the construction of this branch of the game tree is halted and the node is simply marked as a range-term node. A range-term node is denoted in FIG. 3 with an arrow beneath the node.

An additional option available from the root node 0 would be to change only the price term in the counteroffer. Nodes 1, 3, 5, and 7 all contemplate changing the type of shoes (wingtip, loafer) in the counteroffer. Node 9 represents a counteroffer where only the price term has been modified as denoted by the flag with an “R”. Because price is a range term, there are multiple options available from node 9. In particular, when a range term is modified it does not foreclose the possibility of further modifications to that term. Whereas, with a discrete attribute of the deal, a selection would foreclose further changes to the attribute. Accordingly, the available option from node 9 would include changing the shoe type attribute as well as further changing the price. Node 10 represents the selection of wingtips as denoted by the “W” flag on the branch between node 9 and node 10. From node 10, the price may be further modified as represented by node 15. Since the only option from node 15 is further modifications to the price, node 15 represents the same state as that of node 21. Accordingly, when an evaluation of node 21 is completed, the result can be used for the evaluation of node 15 as well. Thus, further construction of the branch can be halted. This relationship between node 15 and node 21 is denoted beneath node 15 with “=21”. Node 12 is a sibling node representing the combined moves of selecting wingtips and a price modification. Sibling nodes are still possible because both attributes (shoe type, price) can still be modified. Since node 12 essentially represents the same state as that of node 4, this branch does not need to be expanded and the notation “=4” is shown in FIG. 3 beneath node 12.

Nodes 11, 16 and 13 are similarly created. Node 11 represents the selection of loafers as denoted by the “L” flag on the branch between node 9 and node 11. From node 11, the price may be further modified as represented by node 16. Since the only option from node 16 is further modifications to the price, node 16 represents the same state as that of node 22. Accordingly, when an evaluation of node 22 is completed, the result can be used for the evaluation of node 16 as well. This relationship between node 16 and node 22 is denoted beneath node 15 with “=22”. Node 13 is a sibling node representing the combined moves selecting loafers and a price modification. Since node 13 essentially represents the same state as that of node 8, this branch does not need to be expanded and the notation “=8” is shown in FIG. 3 beneath node 13. Finally, Node 14 is created beneath Node 9 since even though the price was previously modified the price can continue to be changed, since the price is a range term. Node 14 represents a further offer (from the other party to the negotiation) further modifying the price term as denoted by the “R” on the branch from node 9 to node 14. From this point, the price term can continue to be modified by the parties indefinitely. Accordingly, an indefinite number of nodes could be created beneath node 14 which would all essentially represent the same states as node 9 and node 14. Rather than repeating nodes beneath node 14, the construction of this branch of the game tree is halted and the node is simply marked as a range-term node. A range-term node is denoted in FIG. 3 with an arrow beneath the node.

In this way, the tree has been expanded to a sufficient point to utilize optimization algorithms during the evaluation process to assign payoff values to each of the nodes. Moreover, the construction of the tree has been substantially abbreviated by halting the construction of branches once repetitive range-term nodes are reached, and by utilizing pruning strategies (in this case, recognizing commonality between states of nodes within the game tree).

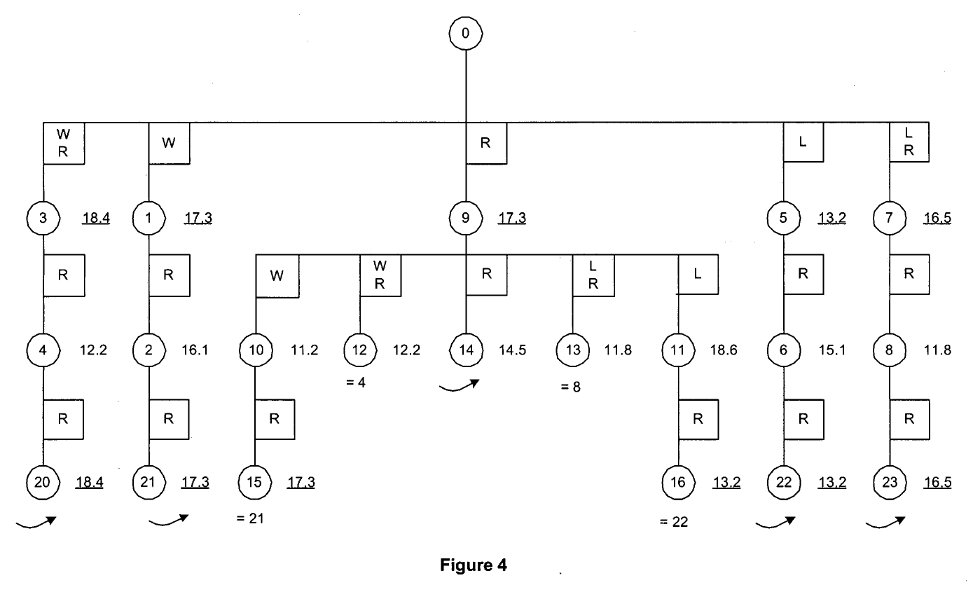

FIG. 4 is a diagram illustrating the evaluation of a game tree for use in an automated negotiation. Once construction of the tree is completed, the evaluation process may begin by computing the payoff value for each terminal node. In standard contests, the payoff value of the terminal nodes is usually represented simply as a −1, 0, or +1. The payoff value will be −1 if the node represents a win for the opponent, 0 if the node represents a draw, and +1 if the node represents a win for the party. In a more complex contest such as a negotiation, the payoff value is determined using the utility functions of the parties involved. An evaluation function that assigns values to different deals is commonly known as a utility function. Using utility functions, the payoff value for each terminal node can be determined. Once the payoff value of each terminal node has been calculated, the value of each non-terminal node can be determined. The value of each non-terminal node is that of the child with the largest value for the party that can move to it. Thus, the values of the terminal nodes can be propagated to the root nodes. In this way, the values of the terminal nodes are propagated up the game tree. Once all the payoff values have been so propagated, and the child nodes beneath the root node are all assigned a payoff value, the child node with the highest available payoff is usually selected as the best option.

FIG. 4 presents the same game tree as that of FIG. 3. Payoff values for the terminal nodes have been determined using utility functions. In addition, optimization algorithms have been used for the range-term nodes. The payoff values are shown in FIG. 4 as a number next to each node. For example, the payoff value for node 20 is “18.4” as shown next to node 20. To avoid confusion, one party's payoff values are underlined while the other party's are not. As shown in FIG. 4, the payoff values are propagated from the terminal nodes to the root nodes. Each level of the game tree represents options available to alternating parties since the nodes represent offers and counteroffers alternating between the parties. Accordingly, the payoff value for node 20, 18.4, propagates to root node 3. Node 3 is a child node of root node 0. Once all payoff values have been similarly propagated from the terminal nodes to the child nodes, the child node with the highest payoff can be selected.

In the context of standard contests, the use of utility functions to determine payoff values for the nodes of the game tree is simplified since the players' desires are known. For example, in most games each party simply wants to win. Thus, evaluating the relative value of a particular outcome is relatively straightforward. Inherent in the concept of negotiation, however, is the recognition that different deals or outcomes may be more or less appealing to different parties. For example, a party may value a pair of Florscheim shoes more highly than a pair of Dexter shoes, while another party may have the opposite preference. Thus, how much a party values a particular attribute or how much weight the party assigns to the attribute may not be known. This type of uncertainty will generally be referred to as payoff uncertainty. This payoff uncertainty may be adequately represented by a mean payoff value (v) and standard deviation (a). Thus, instead of a payoff value having a set value, the payoff value would be noted a mean value ± a standard deviation, for example, a payoff value of 12.2±1.4 instead of simply 12.2.

In the evaluation process, the payoff values at a node may represent the payoff value of the several attribute states represented by that node. Accordingly, payoff values may need to be summed for the various attributes to determine the payoff value for the node. The mean payoff of a particular deal to the opponent is the sum of the mean values assigned to the estimates of the attribute values in the deal. The standard deviation representing the uncertainty in the estimate of the opponent's value of the deal is the square root of the sum of the squares of the standard deviations of the attribute values in the deal. The sums are over all attributes in the utility representation contributing to the payoff. These calculations assume that the distributions for each attribute being summed are independent. This may not always be the case. Any error in making this assumption, however, is probably negligible when compared to the underlying uncertainty in the original estimations. Thus, the calculations are adequate for these purposes.

Given that the payoff values now include a mean and standard deviation, a negative payoff value is possible. Assuming no parties will accept deals having a negative utility to them, we should calculate the probability that a particular deal has a negative utility for at least one of the parties. The probability that a deal has negative utility for a player is the area under the part of the Gaussian distribution assumed to represent the uncertainty that lies to the left of the origin. The probability that the offer will be acceptable to all parties (p₁) is the product of 1 minus these individual rejection probabilities. To account for this likelihood in the evaluation of the game tree, we would multiply the payoffs by the resulting acceptance probabilities.

Considering an example, assume there are two parties, A and B. Party A is selecting between two nodes, node 1 and node 2. Party A will choose the node with the higher payoff value. Party B, however, only has an estimate of party A's utility. Party B does not know how party A values the nodes since there is uncertainty in party B's estimate of how party A values the various attributes of the nodes (payoff uncertainty). Accordingly, party B assigns a mean and standard deviation to party B's estimate of party A's utility. Again we assume that these two values are uncorrelated, which may not always be the case but this error can be included approximately in the standard deviations. Accordingly, the probability that party A will choose node 1 can be determined by computing the part of the Gaussian curve assumed to represent the uncertainty in the value of the deal represented by node 1 that is higher than the corresponding Gaussian curve for node 2. When the node has more than two children, we would have joint probability. So, more generally, the probability that node 1 will be chosen can be determined by calculating that part of the Gaussian that is higher than any of the other Gaussian distributions.

In addition to the above payoff uncertainty, there may also be constraint uncertainty. Constraint uncertainty considers the likelihood that an attribute value or combination of values violates a constraint for one of the parties. For example, a party may insist on using a credit card for payment on merchandise to be shipped. An offer that includes only cash or check as payment options would violate that party's constraints. Such an offer could be assumed to have a payoff value of negative infinity since it results in a failed negotiation. The representation of the parties' utility functions could include an explicit value for the estimation that a particular combination is required. The aggregate acceptance probability (Pᵢ) is computed by taking the product of the acceptance probabilities of the individual terms. This acceptance probability (Pᵢ) and the above-calculated probability that the payoff value is positive (p₁) can be multiplied together and then multiplied by the payoff value, to determine the node's adjusted payoff for the parties.

In sum, the uncertainties addressed here, as well as other potential uncertainties, can be addressed in the evaluation of the game tree by calculating probability functions. These probability functions can then be multiplied by each other and by a node's payoff value to determine an adjusted payoff value for the node. The adjusted payoff value can then be used to select the best option.

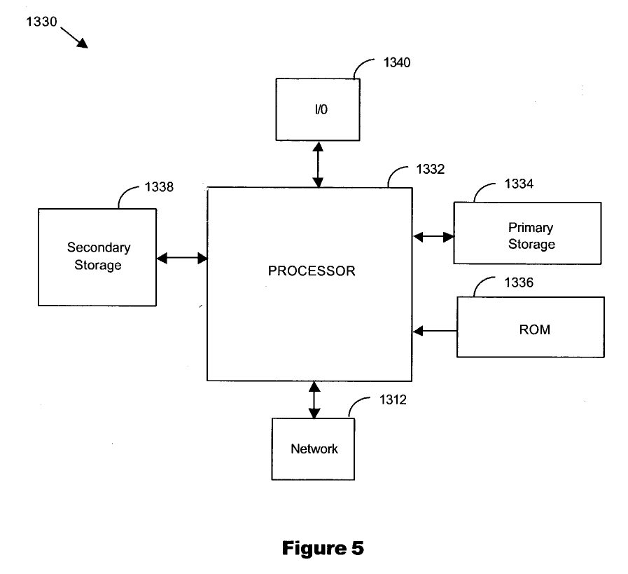

FIG. 5 is a system diagram illustrating an embodiment of a general-purpose computer system on which a method for automated negotiation could be operated in whole or in part. The system and method for automated negotiation as described herein may be implemented in whole or in part on a variety of different computer systems. FIG. 5 illustrates one such general-purpose computer system. The computer system 1330 includes a processor 1332 (also referred to as a central processing unit, or CPU) that is coupled to memory devices including primary storage devices 1336 (such as a read only memory, or ROM) and primary storage devices 1334 (such as a random access memory, or RAM).

Generally, ROM transfers data and instructions uni-directionally to CPU 1332, while RAM typically transfers data and instructions in a bi-directional manner. Both storage devices 1334, 1336 may comprise any suitable computer-readable media. A secondary storage medium 1338, which is typically a mass memory device, is also coupled bi-directionally to CPU 1332 and provides additional data storage capacity. The mass memory device 1338 is a computer-readable medium that may be used to store programs including computer code, data, and the like. Mass memory device 1338 is typically a storage medium utilizing a non-volatile memory such as a hard disk or a tape that is generally slower than primary storage devices 1334, 1336. Mass memory storage device 1338 may take the form of a magnetic or paper tape reader or other known devices. The information retained within the mass memory device 1338 may, in appropriate cases, be incorporated as part of RAM 1336 as virtual memory.

CPU 1332 also couples to one or more input/output devices 1340 that may include devices such as video monitors, track balls, mice, keyboards, microphones, touch-sensitive displays, transducer card readers, magnetic or paper tape readers, tablets, styluses, voice or handwriting recognizers, or other known input/output devices including other computers. Finally, CPU 1332 optionally may be coupled to a computer or telecommunications network, e.g., an Internet network, or an intranet network, using a network connection as shown generally at 1312. With such a network connection, CPU 1332 may receive information from the network, or may output information to the network in the course of performing the processes and methods in accordance with the disclosure herein. Such information is often represented as a sequence of instructions to be executed using CPU 1332. The information may be received from and sent to the network, for example, in the form of a computer data signal embodied in a carrier wave.

In one embodiment, sequences of instructions may be executed substantially simultaneously on multiple CPUs, as for example a CPU in communication across network connections. Specifically, the above-described method may be performed across a computer network. Additionally, one of skill in the art will recognize that the method may be recognized as sets of computer codes and that such computer codes can be stored in computer readable media such as RAM, ROM, hard discs, floppy discs, carrier waves or other storage devices or media.

The above discussion is meant to be illustrative of the principles and various embodiments of the present invention. Numerous variations and modifications will become apparent to those skilled in the art once the above disclosure is fully appreciated For example, other probability distributions could be used to account for uncertainty in the estimate of the other player's utility function. This disclosure makes other principles and modified embodiments apparent to those skilled in the art. The following claims should be interpreted to embrace all such variations and modifications.

What is claimed is:

1. A processor-based method for automated negotiation, comprising:
constructing a game tree based on an offer received from an opponent;
evaluating the game tree; and
selecting a counteroffer based on the evaluation of the game tree.

2. The method of claim 1, further comprising:
presenting the counteroffer to the opponent.

3. The method of claim 1, wherein constructing a game tree comprises:
determining whether the offer received is a legal offer.

4. The method of claim 3, wherein the offer is rejected if it is not a legal offer and no counteroffer is selected.

5. The method of claim 1, wherein the offer is a legal offer if it narrows the terms of the negotiation.

6. The method of claim 1, further comprising:
awaiting a subsequent offer from the opponent and repeating the method on each subsequent offer.

7. The method of claim 1, wherein the negotiation is a business deal and wherein the attributes of the negotiation define the terms of a business transaction.

8. The method of claim 1, wherein the negotiation has the potential for compound moves that can change more than one attribute in a legal offer.

9. The method of claim 1, wherein the negotiation has range terms that can be changed in a legal offer.

10. The method of claim 1, wherein evaluating the game tree accommodates uncertainty in the negotiation.

11. A processor-based method for automated negotiation, comprising:
receiving an offer from an opponent;
determining if the offer is a legal offer that narrows terms of the negotiation;
rejecting the offer if it is not a legal offer; and
if the offer is a legal offer, the method further comprising:
constructing a game tree based on the current offer;
evaluating the game tree;
selecting a counteroffer based on the evaluation of the game tree; and
presenting the counteroffer to the opponent.

12. The method of claim 11, wherein constructing the game tree based on the current offer comprises:
defining the current offer as the root node;
creating child nodes from the root node for every legal counteroffer to the current offer; and
recursively creating additional nodes representing legal moves from the child nodes and additional nodes.

13. The method of claim 12, wherein evaluating the game tree comprises assigning a payoff value to each child node.

14. The method of claim 13, wherein selecting a counteroffer based on the evaluation of the game tree comprises selecting the child node in the game tree having the highest payoff value.

15. The method of claim 11, wherein constructing a game tree comprises creating sibling nodes representing compound moves that can change more than one attribute in a legal offer.

16. The method of claim 11, wherein constructing a game tree comprises creating nodes that accommodate the potential for range terms that can be changed in a legal offer.

17. The method of claim 16, wherein evaluating the game tree comprises using an optimization algorithm.

18. The method of claim 11, wherein evaluating the game tree comprises accommodating the potential for uncertainty in the negotiation.

19. The method of claim 18, wherein evaluating the game tree further comprises:
using a utility function and a probability function to account for the uncertainty in evaluating the game tree.

20. Computer-readable media tangibly embodying a program of instructions executable by a computer to perform a method for automated negotiation, the method comprising:
determining a counteroffer to an offer received from an opponent based on an evaluation of a game tree constructed based on the offer and available counteroffers.

21. The media of claim 20 wherein the counteroffer has the highest payoff of the available counteroffers represented in the game tree.

22. The media of claim 20 wherein construction and evaluation of the game tree accommodates compound moves, range terms, and uncertainty in the negotiation.

23. A system for automated negotiation, comprising:
means for constructing a game tree based on a legal offer received from an opponent;
means for evaluating the game tree; and
means for selecting a counteroffer based on the evaluation of the game tree.

24. The method of claim 23, further comprising:
means for accommodating compound moves that can change more than one attribute in a legal offer.

25. The method of claim 23, further comprising:
means for accommodating range terms that can be changed in a legal offer.

26. The method of claim 23, further comprising:
means for accommodating uncertainty in the negotiation.

27. The method of claim 23, wherein the means for constructing a game tree comprises means for pruning the game tree during construction.

28. The method of claim 25, wherein the means for accommodating range terms comprises means for imposing a granularity on the range terms.
